(19) United States
(12) Patent Application Publication
(10) Pub. No.: US 2026/0121214 A1
(43) Pub. Date: Apr. 30, 2026

(54) HIGH VOLTAGE BATTERY MODULE TO REDUCE THERMAL RUNAWAY PROPAGATION

(71) Applicant: FCA US LLC, Auburn Hills, MI (US)

(72) Inventor: Yi Zheng, Auburn Hills, MI (US)

(21) Appl. No.: 18/929,833

(22) Filed: Oct. 29, 2024

(51) Int. Cl. H01M 50/367; H01M 50/204; H01M 50/249; H01M 50/276

(52) U.S. Cl. CPC H01M 50/367; H01M 50/249; H01M 50/276; H01M 50/204

(57) ABSTRACT

A battery pack module for an electric vehicle high voltage (HV) battery system includes a housing having a top cover, a plurality of battery cells disposed within the battery pack module housing, a plurality of venting slots formed within the top cover and configured to vent gases and particles during a thermal runaway event, and a flange extending upwardly from an exterior surface of the top cover and at least partially surrounding each venting slot. The flange creates a raised venting passage configured to direct the gases and particles from the venting slot upward and away from the top cover to prevent the gases and particles from re-entering the venting slot from which they originated or entering an adjacent venting slot.

### FIELD

The present application relates generally to electrified vehicles and, more particularly, to a battery pack module with a venting lid to reduce thermal runaway propagation.

### BACKGROUND

Electrified vehicles include one or more electric motors configured to generate mechanical drive torque using electrical energy (e.g., current) provided by a high voltage battery system. A “thermal runaway” is a potentially problematic situation for a battery system where a self-ignition occurs when there is a sudden release of stored energy in the cell due to some type of internal short circuit. This rapid rise in temperature of one cell can result in a thermal event which can then spread rapidly to adjacent cells. During some thermal runaway events, hot gases or particles coming out of the degassing vents could spread or disperse to other cells and pose a fire hazard. Known thermal runaway mitigation techniques include use of flame-retardant material, particular battery cell chemistry (e.g., lithium iron phosphate), or prismatic cell form factors. However, these techniques may only mitigate flames to a certain degree and lower driving range. Accordingly, while such conventional electrified vehicle battery management techniques do work well for their intended purpose, there exists an opportunity for improvement in the relevant art.

### SUMMARY

In accordance with one example aspect of the invention, a battery pack module for an electric vehicle high voltage (HV) battery system is provided. In one exemplary implementation, the battery pack module includes a housing having a top cover, a plurality of battery cells disposed within the battery pack module housing, a plurality of venting slots formed within the top cover and configured to vent gases and particles during a thermal runaway event, and a flange extending upwardly from an exterior surface of the top cover and at least partially surrounding each venting slot. The flange creates a raised venting passage configured to direct the gases and particles from the venting slot upward and away from the top cover to prevent the gases and particles from re-entering the venting slot from which they originated or entering an adjacent venting slot.

In addition to the foregoing, the described battery pack module may include one or more of the following features: wherein the flange is disposed along a perimeter of the venting slot; wherein the flange circumscribes the venting slot; wherein the housing includes the top cover, a bottom wall, a pair of opposed end plates, and a pair of opposed sidewalls; wherein each venting slot has a width between approximately 4.0 mm and approximately 6.0 mm; wherein each flange has a height of between approximately 3.0 mm and approximately 5.0 mm; wherein the top cover is fabricated from aluminum; and wherein the flange for each venting slot is integrally formed with the top cover.

In accordance with one example aspect of the invention, a battery pack assembly for an electrified vehicle high voltage (HV) battery system is provided. In one exemplary implementation, the battery pack assembly includes a main housing configured to couple to a vehicle frame, the main housing including a lid, and a plurality of battery pack modules disposed within the main housing. Each battery pack module includes a module housing having a top cover, a plurality of battery cells disposed within the battery pack module housing, a plurality of venting slots formed within the top cover and configured to vent gases and particles during a thermal runaway event, and a flange extending upwardly from an exterior surface of the top cover and at least partially surrounding each venting slot. The flange creates a raised venting passage configured to direct the gases and particles from the venting slot upward and away from the top cover to prevent the gases and particles from re-entering the venting slot from which they originated or entering an adjacent venting slot.

In addition to the foregoing, the described battery pack assembly may include one or more of the following features: wherein the flange is disposed along a perimeter of the venting slot; wherein the flange circumscribes the venting slot; wherein the module housing includes the top cover, a bottom wall, a pair of opposed end plates, and a pair of opposed sidewalls; wherein each venting slot has a width between approximately 4.0 mm and approximately 6.0 mm; and wherein each flange has a height of between approximately 3.0 mm and approximately 5.0 mm.

In addition to the foregoing, the described battery pack assembly may include one or more of the following features: wherein each battery pack module is disposed within the main housing such that an air clearance passage is established between the module top cover and the main housing lid, wherein the air clearance passage has a height of between approximately 10 mm and approximately 14 mm; wherein each venting slot has a width between approximately 4.0 mm and approximately 6.0 mm, and wherein each flange has a height of between approximately 3.0 mm and approximately 5.0 mm; wherein the top cover is fabricated from aluminum; and wherein the flange for each venting slot is integrally formed with the top cover.

Further areas of applicability of the teachings of the present disclosure will become apparent from the detailed description, claims and the drawings provided hereinafter, wherein like reference numerals refer to like features throughout the several views of the drawings. It should be understood that the detailed description, including disclosed embodiments and drawings references therein, are merely exemplary in nature intended for purposes of illustration only and are not intended to limit the scope of the present disclosure, its application or uses. Thus, variations that do not depart from the gist of the present disclosure are intended to be within the scope of the present disclosure.

### BRIEF DESCRIPTION OF THE DRAWINGS

FIG. 1 is a functional block diagram of an example electrified vehicle having a battery pack assembly in accordance with the principles of the present application;

FIG. 2 is a sectional view of an example high voltage battery module of the vehicle shown in FIG. 1, in accordance with the principles of the present application;

FIG. 3 is a cross-sectional view of the high voltage battery module shown in FIG. 2 and taken along line 3-3, in accordance with the principles of the present application;

FIG. 4 is an enlarged view of a portion of the high voltage battery module shown in FIG. 2, in accordance with the principles of the present application; and

FIG. 5 is a schematic cross-sectional view of an example battery pack assembly and battery module venting arrangement, in accordance with the principles of the present application.

### DETAILED DESCRIPTION

As previously discussed, “thermal runaway” refers to the scenario when a battery cell self-ignition causes a thermal event that can rapidly spread to adjacent battery cells and potentially damage the HV battery system and cause thermal propagation in the battery system. During such a thermal runaway event, it is important to prevent gases and particles expelled from the trigger cell from affecting surrounding cells. Accordingly, systems and methods are provided herein for a battery pack module with a top plate designed to facilitate the venting of gases/particles generated by thermal runaway of the triggered cell to the exterior of the module. The battery pack module also minimizes the potential for re-entry of these gases and particles back into the battery pack module by significantly decreasing particle momentum.

In one example, a high voltage (HV) battery pack module includes a housing with a top cover having a plurality of venting holes or slots to vent gases/particles expelled from a trigger cell during a thermal runaway event caused by self-sustaining exothermic reactions. A wall or flange extends upwardly from a top surface of the top cover and circumscribes or surrounds each venting slot. This creates a “chimney” around each venting slot to vent gases/particles from the module and prevent re-entry in adjacent venting slots, which could cause thermal runaway propagation in adjacent battery cells.

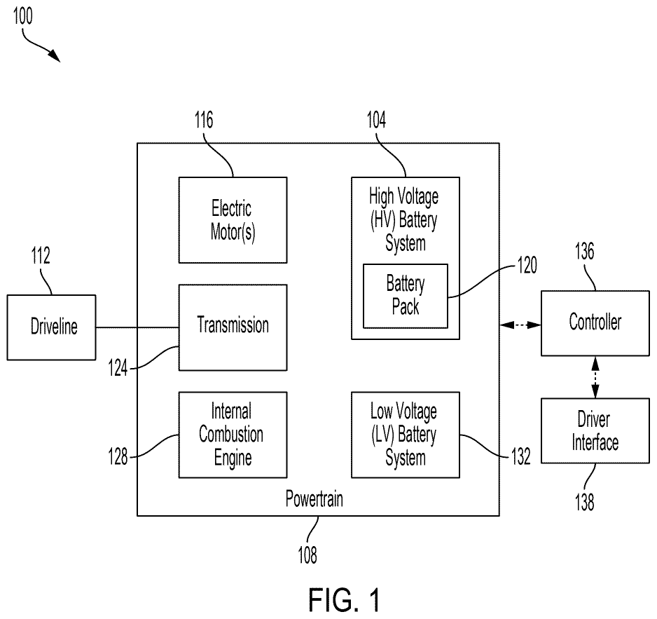

With initial reference to FIG. 1, a functional block diagram of an electrified vehicle 100 having an example high voltage (HV) battery system 104 according to the principles of the present application is illustrated. The electrified vehicle 100 could be any suitable type of electrified vehicle, including, but not limited to, a battery electric vehicle (BEV) or a plug-in hybrid electric vehicle (PHEV). The electrified vehicle 100 comprises an electrified powertrain 108 configured to generate and transfer drive torque to a driveline 112 for vehicle propulsion. The electrified powertrain 108 includes one or more electric traction motors 116 each configured to generate mechanical drive torque using energy (e.g., electrical current) supplied by the high voltage battery system 104, which includes a HV battery pack assembly 120. For example, an inverter (not shown) could be used to convert the direct current (DC) from the high voltage battery system 104 to three-phase alternating current (AC) to power the electric traction motor(s) 116. A transmission 124 (e.g., an automatic transmission) is configured to transfer the drive torque from the electrified powertrain 108 to the driveline 112.

The electrified powertrain 108 also includes an optional internal combustion engine 128 configured to combust a mixture of air and fuel (gasoline, diesel, etc.) to generate mechanical torque for vehicle propulsion and/or conversion to electrical energy, such as for battery system recharging. A low voltage battery system 132 (e.g., a 12-volt (V) battery) is configured to power low voltage components and accessory loads of the electrified vehicle 100. A controller 136 is configured to control the electrified powertrain 108, including controlling the electrified powertrain to generate an amount of drive torque to satisfy a torque request provided by a driver/operator via a driver interface 138 (e.g., an accelerator pedal).

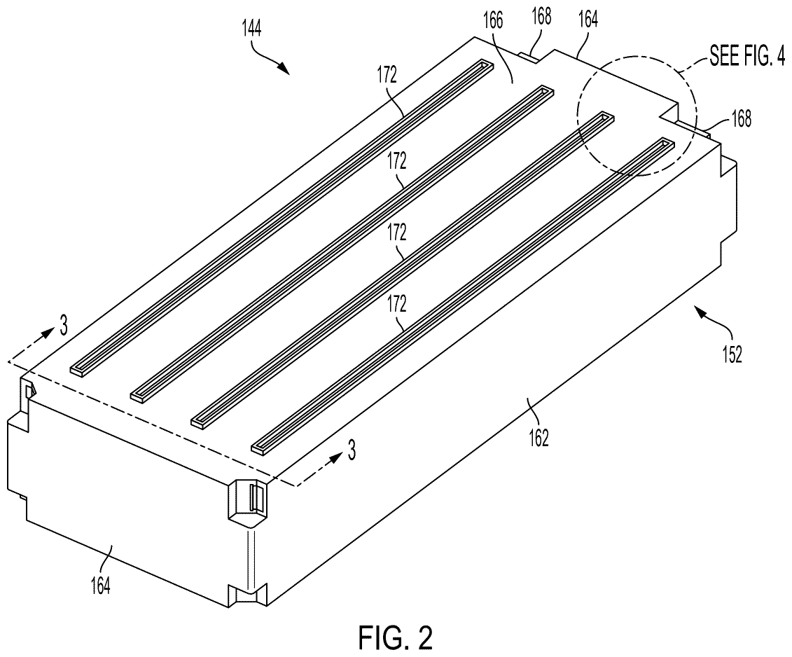

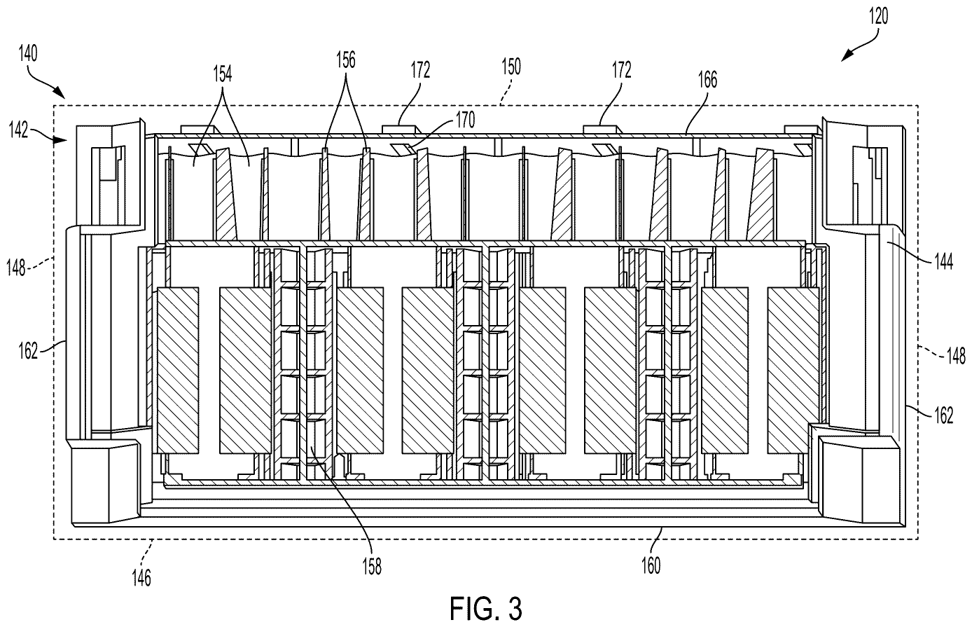

With reference now to FIGS. 2 and 3, additional features of the battery pack assembly 120 will be described in more detail. The battery pack assembly 120 generally includes a main housing 140 configured to receive and house a battery pack 142 made up of one or more individual battery modules 144 (only one shown). As shown in FIG. 3, the battery pack housing 140 is configured to secure to a vehicle frame (not shown) and generally includes a bottom wall 146, sidewalls 148, and a top cover or lid 150.

In the example embodiment, as shown in FIGS. 2 and 3, each battery module 144 generally includes a housing 152 configured to house a plurality of battery cells 154 and a plurality of busbars 156 supported by one or more busbar holders 158. The module housing 152 can be formed of aluminum and generally includes a bottom wall 160, opposed sidewalls 162, opposed end plates 164, and a top lid or cover 166. One or both of the end plates 164 define electrical terminals 168 for connecting each battery module 144 to the vehicle HV electrical system.

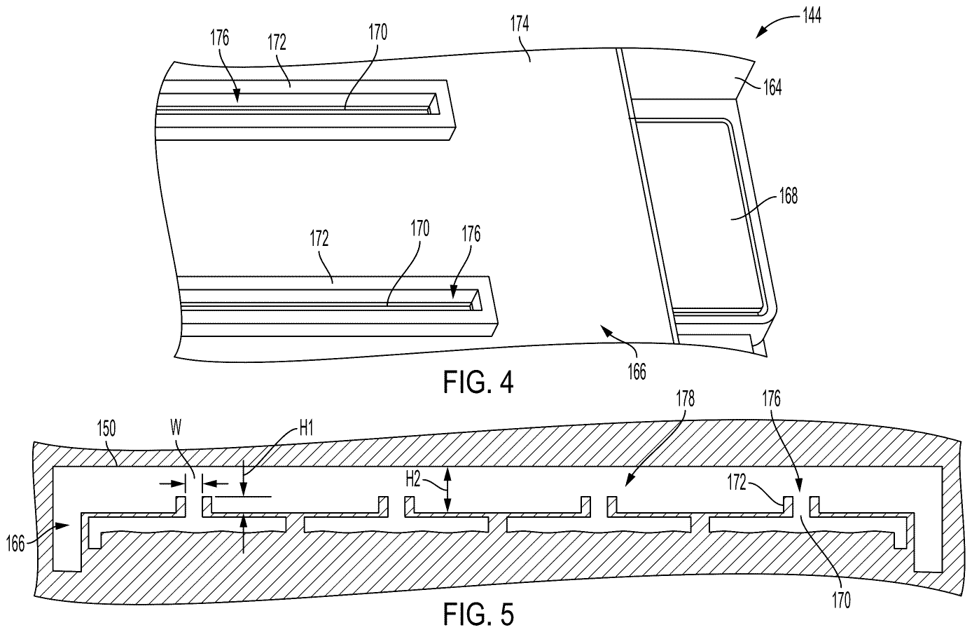

With reference now to FIGS. 2 and 4, in the example embodiment, the battery module top cover 166 includes one or more venting holes or slots 170. In the example embodiment, the venting slots 170 extend between end plates 164 parallel to or generally parallel to the sidewalls 162. However, it will be appreciated that venting slots 170 have various shapes, lengths, and arrangements on top cover 166. Moreover, although four venting slots 170 are shown, it will be appreciated that top cover 166 may have any suitable number of venting slots 170 that enables battery module 144 to function as described herein.

In the example embodiment, the venting slots 170 are configured to allow gases and particles generated by a thermal runaway of a triggered battery cell 154. As shown in FIG. 4, each venting slot 170 is at least partially surrounded or circumscribed by a wall or flange 172 extending upwardly from an exterior top surface 174 of the module top cover 166. In other words, the flange 172 extends around a perimeter of the venting slot 170 to create a raised or elongated chimney-like venting passage 176. The flange 172 may be integrally formed with the module top cover 166 (e.g., molding, stamping, cast, etc.) or later coupled to the module top cover 166 via a suitable method (e.g., welding, adhesive, etc.).

Advantageously, the flange 172 facilitates preventing thermal runaway gases and particles from re-entering the venting slot 170 from which they came, or from entering adjacent venting slots 170, which could cause further thermal runaway propagation. Additionally, the flange 172 directs gases and particles upward and away from the top cover 166 toward the battery pack housing lid 150 such that they can subsequently be vented from the battery pack main housing 140. Without flanges 172, it has been found that gases and particles may exit the venting slot 170 and travel along the exterior top surface 174.

FIG. 5 illustrates an example cross-sectional view of the battery module top cover 166 assembled within battery pack main housing 140 and disposed below the battery pack housing lid 150. An air clearance passage 178 is defined between the module top cover 166 and the battery pack housing lid 150. In the example embodiment, each venting slot 170 has a width ‘W’ and each venting slot flange 172 has a height ‘H1’ above the exterior top surface 174. The air clearance passage 178 has a height ‘H2’ between the exterior top surface 174 and the battery pack housing lid 150.

In one example, width ‘W’ is between approximately 4.0 mm and approximately 6.0 mm, or between 4.0 mm and 6.0 mm. In another example, width ‘W’ is 5.0 mm or approximately 5.0 mm. In one example, height ‘H1’ is between approximately 3.0 m and approximately 5.0 mm, or between 3.0 mm and 5.0 mm. In another example, height ‘H1’ is 4.2 mm or approximately 4.2 mm. In one example, height ‘H2’ is between approximately 10 mm and approximately 14 mm, or between 10 mm and 14 mm. In another example, height ‘H2’ is 12 mm or approximately 12 mm.

Described herein are systems and methods for preventing or delaying propagation of a thermal runaway event in a HV battery system. The system includes a plurality of battery modules each having a top cover with venting slots formed therein. Each venting slot is at least partially surrounded by an upwardly extending flange to create a chimney or vertically extending passage configured to direct thermal runaway gases and particles upward and away from the battery module top cover to prevent thermal runaway propagation to adjacent battery cells.

It will be appreciated that the terms “controller” or “control system” or “module” as used herein refer to any suitable control device or set of multiple control devices that is/are configured to perform at least a portion of the techniques of the present application. Non-limiting examples include an application-specific integrated circuit (ASIC), one or more processors and a non-transitory memory having instructions stored thereon that, when executed by the one or more processors, cause the controller to perform a set of operations corresponding to at least a portion of the techniques of the present application. The one or more processors could be either a single processor or two or more processors operating in a parallel or distributed architecture.

It will be understood that the mixing and matching of features, elements, methodologies, systems and/or functions between various examples may be expressly contemplated herein so that one skilled in the art will appreciate from the present teachings that features, elements, systems and/or functions of one example may be incorporated into another example as appropriate, unless described otherwise above. It will also be understood that the description, including disclosed examples and drawings, is merely exemplary in nature intended for purposes of illustration only and is not intended to limit the scope of the present application, its application or uses. Thus, variations that do not depart from the gist of the present application are intended to be within the scope of the present application.

What is claimed is:

1. A battery pack module for an electric vehicle high voltage (HV) battery system, the battery pack module comprising:
a housing having a top cover;
a plurality of battery cells disposed within the battery pack module housing;
a plurality of venting slots formed within the top cover and configured to vent gases and particles during a thermal runaway event; and
a flange extending upwardly from an exterior surface of the top cover and at least partially surrounding each venting slot,
wherein the flange creates a raised venting passage configured to direct the gases and particles from the venting slot upward and away from the top cover to prevent the gases and particles from re-entering the venting slot from which they originated or entering an adjacent venting slot.

2. The battery pack module of claim 1, wherein the flange is disposed along a perimeter of the venting slot.

3. The battery pack module of claim 1, wherein the flange circumscribes the venting slot.

4. The battery pack module of claim 1, wherein the housing comprises:
the top cover;
a bottom wall;
a pair of opposed end plates; and
a pair of opposed sidewalls.

5. The battery pack module of claim 1, wherein each venting slot has a width between approximately 4.0 mm and approximately 6.0 mm.

6. The battery pack module of claim 1, wherein each flange has a height of between approximately 3.0 mm and approximately 5.0 mm.

7. The battery pack module of claim 1, wherein the top cover is fabricated from aluminum.

8. The battery pack module of claim 1, wherein the flange for each venting slot is integrally formed with the top cover.

9. A battery pack assembly for an electrified vehicle high voltage (HV) battery system, the battery pack assembly comprising:
a main housing configured to couple to a vehicle frame, the main housing including a lid; and
a plurality of battery pack modules disposed within the main housing, each battery pack module comprising:
a module housing having a top cover;
a plurality of battery cells disposed within the battery pack module housing;
a plurality of venting slots formed within the top cover and configured to vent gases and particles during a thermal runaway event; and
a flange extending upwardly from an exterior surface of the top cover and at least partially surrounding each venting slot,
wherein the flange creates a raised venting passage configured to direct the gases and particles from the venting slot upward and away from the top cover to prevent the gases and particles from re-entering the venting slot from which they originated or entering an adjacent venting slot.

10. The battery pack assembly of claim 9, wherein the flange is disposed along a perimeter of the venting slot.

11. The battery pack assembly of claim 9, wherein the flange circumscribes the venting slot.

12. The battery pack assembly of claim 9, wherein the module housing comprises:
the top cover;
a bottom wall;
a pair of opposed end plates; and
a pair of opposed sidewalls.

13. The battery pack assembly of claim 9, wherein each venting slot has a width between approximately 4.0 mm and approximately 6.0 mm.

14. The battery pack assembly of claim 9, wherein each flange has a height of between approximately 3.0 mm and approximately 5.0 mm.

15. The battery pack assembly of claim 9, wherein each battery pack module is disposed within the main housing such that an air clearance passage is established between the module top cover and the main housing lid,
wherein the air clearance passage has a height of between approximately 10 mm and approximately 14 mm.

16. The battery pack assembly of claim 15, wherein each venting slot has a width between approximately 4.0 mm and approximately 6.0 mm, and
wherein each flange has a height of between approximately 3.0 mm and approximately 5.0 mm.

17. The battery pack assembly of claim 9, wherein the top cover is fabricated from aluminum.

18. The battery pack assembly of claim 9, wherein the flange for each venting slot is integrally formed with the top cover.
